(19) United States
(12) Patent Application Publication
(10) Pub. No.: US 2016/0062412 A1
(43) Pub. Date: Mar. 3, 2016

(54) FOLDABLE DEVICE

(71) Applicant: SAMSUNG ELECTRONICS CO., LTD., Suwon-si (KR)

(72) Inventors: Jin-hyoung PARK, Suwon-si (KR); Jin-ho KIM, Hanam-si (KR); Kyung-wan PARK, Suwon-si (KR); Ho-seong SEO, Suwon-si (KR); Ga-eun LEE, Daejeon (KR); Shi-yun CHO, Anyang-si (KR)

(73) Assignee: SAMSUNG ELECTRONICS CO., LTD., Suwon-si (KR)

(21) Appl. No.: 14/624,746

(22) Filed: Feb. 18, 2015

(30) Foreign Application Priority Data
Aug. 26, 2014 (KR) 10-2014-0111626

(51) Int. Cl. G06F 1/16

(52) U.S. Cl. CPC G06F 1/1656; G06F 1/1616; G06F 1/1677; G06F 1/1681; G06F 1/1652

(57) ABSTRACT

A foldable device includes: a flexible display device; and a first body and a second body that support the flexible display, are foldably connected to each other and configured to deform between a folded position and an unfolded position. A heating member is controlled to heat a portion of the flexible display disposed at a location between which the first body and the second body are connected. A controller is configured to drive the heating member to heat the portion in response to the deformation.

### CROSS REFERENCE TO RELATED APPLICATION

This application claims priority from Korean Patent Application No. 10-2014-0111626, filed on Aug. 26, 2014, in the Korean Intellectual Property Office, the disclosure of which is incorporated herein by reference in its entirety.

### BACKGROUND

1. Field

Methods and apparatuses consistent with exemplary embodiments relate to a foldable device including a flexible display device.

2. Description of Related Art

A portable foldable device (hereinafter, referred to as a mobile device), such as a communication terminal, a game console, a multimedia device, a portable computer, or a photographing apparatus, generally includes a display device that displays image information, and an input unit, such as a keypad. Many mobile devices include a foldable structure that may fold in order to improve portability. In such mobile devices, two bodies are connected to each other by using the foldable structure. Because a conventional display device may not fold, the conventional display device may be disposed on either one of the two bodies. Hence, it is difficult to apply a large display device to a mobile device including a foldable structure.

As a bendable flexible display device has been developed, attempts have been made to incorporate the flexible display device into a mobile device including a foldable structure. In this case, because the flexible display device may be disposed over two bodies to cross the foldable structure, a large screen may be provided. However, although the flexible display device may be bent, if the flexible display device is sharply bent, the flexible display device may be damaged. Hence, a curved portion having a predetermined curvature is formed at the center of the flexible display device when the flexible display device folds. However, when the flexible display device folds for a long time and then unfolds, the curved portion may not be spread flat.

### SUMMARY

According to one or more exemplary embodiments, a foldable device includes: a flexible display device; a first body and a second body that support the flexible display, are the first body and the second body are foldably connected to each other and configured to deform between a folded position and an unfolded position; a heating member configured to heat a portion of the flexible display disposed at a location between which the first body and the second body are connected; and a controller configured to drive the heating member to heat the portion in response to the deformation.

The heating member may be disposed at the location between which the first body and the second body are connected.

The heating member may include a plurality of the heating members that are respectively disposed on a central portion of the flexible display, a portion of the flexible display at an edge of the first body and a portion of the flexible display at an edge of the second body.

The foldable device may further include a temperature sensor configured to detect a temperature of the portion, wherein the controller drives the heating member based on the temperature of the portion.

The foldable device may further include a fold operation sensor configured to determine movement of the first and second bodies between the folded position and the unfolded position, wherein the controller is configured to detect deformation based on a detection signal of the fold operation sensor and drive the heating member based on the detection signal.

The fold operation sensor may include a strain gauge having a resistance value that varies according to the deformation, wherein the controller is configured to determine at least one of a folding operation and an unfolding operation based on a change in the resistance value.

When the resistance value decreases to reach a first critical value, the controller may be configured to determine a start of the unfolding operation and drive the heating member to start heating the portion.

When the resistance value maintains a value, the controller may be configured to disable the heating member.

When the resistance value increases to reach a second critical value, the controller may be configured to determine a start of the folding operation and drive the heating member to start heating the portion.

When the resistance value maintains a value, the controller may be configured to disable the heating member.

According to another aspect of an exemplary embodiment, a portable device includes: a flexible display; a sensor configured to detect active deformation of the flexible display and output a fold status signal indicating the active deformation; a heater configured to heat a portion of the flexible display; and a controller configured to control the heater to heat the portion in accordance with the fold status signal.

The portable device may include a first body foldably connected to a second body via a hinge member. The flexible display may be supported by the first body and the second body and the heater may be disposed adjacent to a portion of the flexible display that corresponds to a position of the hinge member.

The controller may be further configured to heat the portion in response to the sensor outputting the fold status signal.

The controller may be further configured to disable heating the portion in response to the sensor detects absence of active deformation.

The controller may be further configured to disable heating the portion in response to expiration of a maximum heating time.

According to another aspect of an exemplary embodiment, a method of protecting a flexible display includes: detecting active deformation of a flexible display panel and outputting a fold status signal indicating the detected active deformation; and based on the determining, heating a portion of the flexible display panel by using a heater.

The flexible display may be formed within a first body and a second body that are connected via a hinge member, and the portion of the flexible display panel may correspond to a position of the hinge member.

The portion may be heated in response to determining a deformation of the flexible display panel.

The heating of the portion may be disabled in response to detecting absence of active deformation.

The heating of the portion may be disabled in response to expiration of a maximum heating time.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a perspective view illustrating an outer appearance of a foldable device according to an exemplary embodiment;

FIG. 2 is a side view illustrating an unfolded state of the foldable device of FIG. 1, according to an exemplary embodiment;

FIG. 3 is a side view illustrating a folded state of the foldable device of FIG. 1, according to an exemplary embodiment;

FIG. 4 is a cross-sectional view illustrating a flexible display device according to an exemplary embodiment;

FIG. 5 is an exploded perspective view illustrating the foldable device of FIG. 1, according to an exemplary embodiment;

FIG. 6 is an enlarged view illustrating portion A of FIG. 5, according to an exemplary embodiment;

FIG. 7 is a cross-sectional view taken along line B-B′ of FIG. 6, according to an exemplary embodiment;

FIG. 8A is a side view illustrating a modified connection structure for foldably connecting first and second bodies according to an exemplary embodiment;

FIG. 8B is a side view illustrating misaligned first and second bodies in an unfolded state according to an exemplary embodiment;

FIG. 9 is a side view illustrating a foldable device according to an exemplary embodiment;

FIG. 10 is a side view illustrating a folded state of the foldable device, according to an exemplary embodiment;

FIG. 11 is a rear view illustrating a flexible display device to which a heating member is applied, according to an exemplary embodiment;

FIG. 12 is a rear view illustrating a flexible display device to which a plurality of heating members are applied, according to an exemplary embodiment;

FIG. 13 is a plan view illustrating a heating member realized by using a transparent electrode of a touch panel, according to an exemplary embodiment;

FIG. 14 is a graph illustrating a relationship between a folded angle of the foldable device and a resistance value of a strain gauge, according to an exemplary embodiment; and

FIGS. 15 and 16 are flowcharts of a folding/unfolding process according to an exemplary embodiment.

### DETAILED DESCRIPTION

Reference will now be made in detail to exemplary embodiments, examples of which are illustrated in the accompanying drawings, wherein like reference numerals denote like elements throughout and sizes or thicknesses of elements may be exaggerated for clarity. As used herein, the term “and/or” includes any and all combinations of one or more of the associated listed items. Expressions such as “at least one of,” when preceding a list of elements, modify the entire list of elements and do not modify the individual elements of the list.

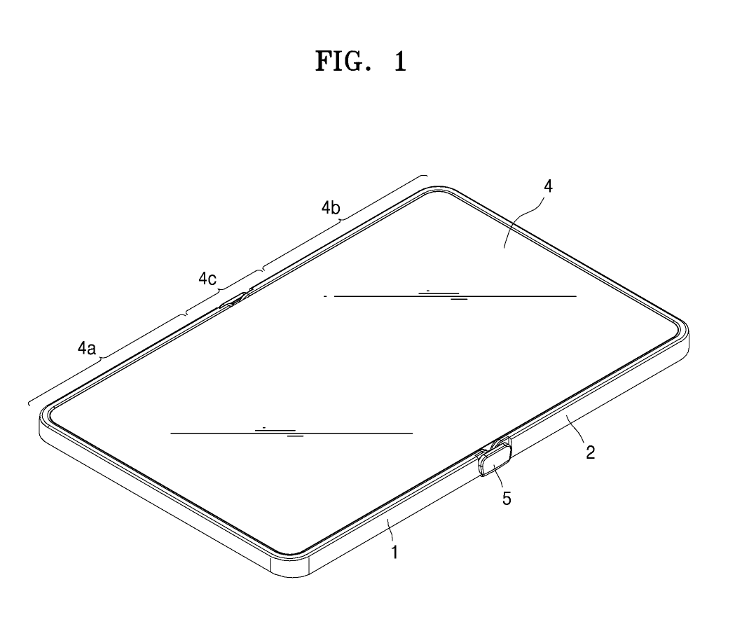

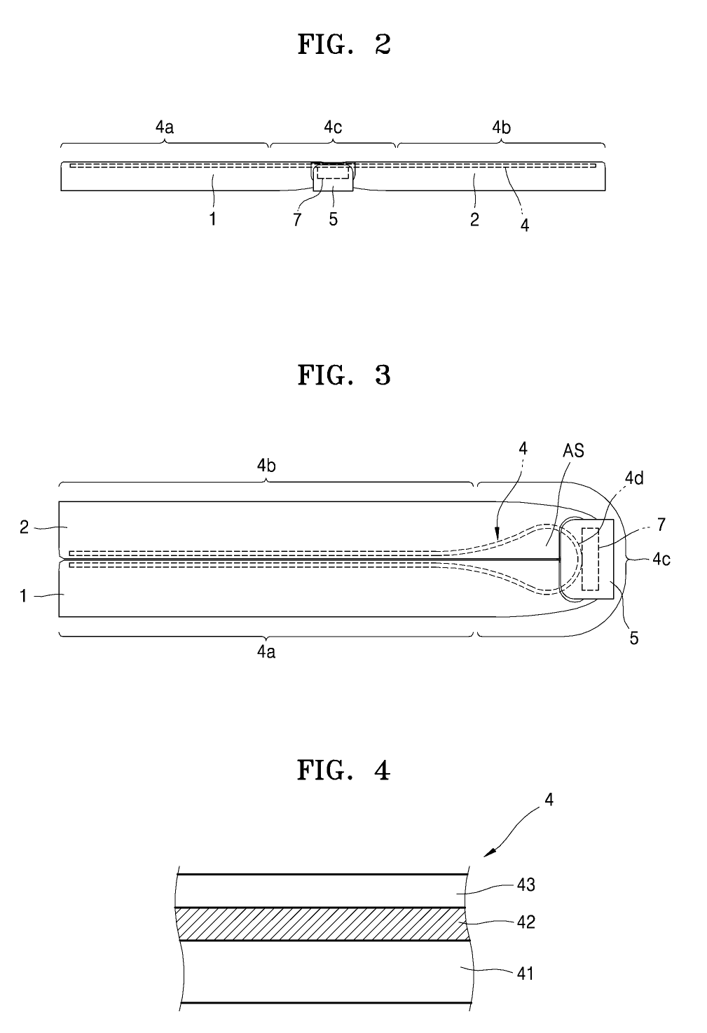

FIG. 1 is a perspective view illustrating an outer appearance of a foldable device according to an exemplary embodiment. FIG. 2 is a side view illustrating an unfolded state of the foldable device of FIG. 1, according to an exemplary embodiment. FIG. 3 is a side view illustrating a folded state of the foldable device of FIG. 1, according to an exemplary embodiment.

Referring to FIGS. 1 through 3, the foldable device includes first body 1, second body 2 and a flexible display device 4. The first and second bodies 1 and 2 are connected to each other to change between an unfolded position, as shown in FIG. 2, and a folded position, as shown in FIG. 3.

The flexible display device 4 is supported by the first body 1 and the second body 2. The flexible display device 4 may be divided into a first part 4a that is supported by the first body 1, a second part 4b that is supported by the second body 2, and a third part 4c that is formed between the first part 4a and the second part 4b. For example, the flexible display device 4 may be adhered to the first body 1 and the second body 2 by using an adhesive, such as double-sided tape. The third part 4c of the flexible display device 4 is not supported by the first body 1 or the second body 2. That is, the third part 4c is not adhered to the first and second bodies 1 and 2. When the first and second bodies 1 and 2 are oriented as shown in FIG. 3, the third part 4c forms a curved portion 4d having a predetermined radius of curvature. Accordingly, because the flexible display device 4 may not be sharply bent and the third part 4c is bent by forming the curved portion 4d, the first and second bodies 1 and 2 may change between the folded position and the unfolded position.

The foldable device may be a portable mobile device, such as a communication terminal, a game player, a multimedia device, a portable computer, or a photographing apparatus. However, exemplary embodiments are not limited thereto, and the foldable device may be any device as long as it includes the first body 1 that supports the first part 4a of the flexible display device 4, and the second body 2 that supports the second part 4b of the flexible display device 4 and is foldably connected to the first body 1.

FIG. 4 is a cross-sectional view illustrating the flexible display device 4 according to an exemplary embodiment.

Referring to FIG. 4, the flexible display device 4 may include a flexible display panel 41 that may display an image and a transparent protective panel 43 that is disposed outside the flexible display panel 41. The flexible display panel 41 may be, for example, an organic light-emitting diode (OLED) panel. When the flexible display panel 41 is an OLED panel, an organic light-emitting layer may be disposed between an upper substrate and a lower substrate. A polarization plate may be disposed on the upper substrate. The upper substrate may emit light. Also, the flexible display device 4 may further include a touch panel 42. The touch panel 42 may be disposed between the transparent protective panel 43 and the flexible display panel 41. The flexible display panel 41, the touch panel 42, and the transparent protective panel 43 may be adhered to one another by using an optically-clear adhesive (OCA) layer. However, exemplary embodiments are not limited thereto, and the flexible display device 4 may further include any of various other optical panels or optical films.

A processing unit and an input/output unit for performing functions may be provided on the first and second bodies 1 and 2. When the foldable device is a multimedia terminal that provides images and music to a user, the processing unit may include an image/audio information processing unit. When the foldable device is a communication terminal, the processing unit may include a communication module. The input/output unit may include an image/audio input/output unit and a manipulation unit for user manipulation. The manipulation unit may be the touch panel 42 of the flexible display device 4.

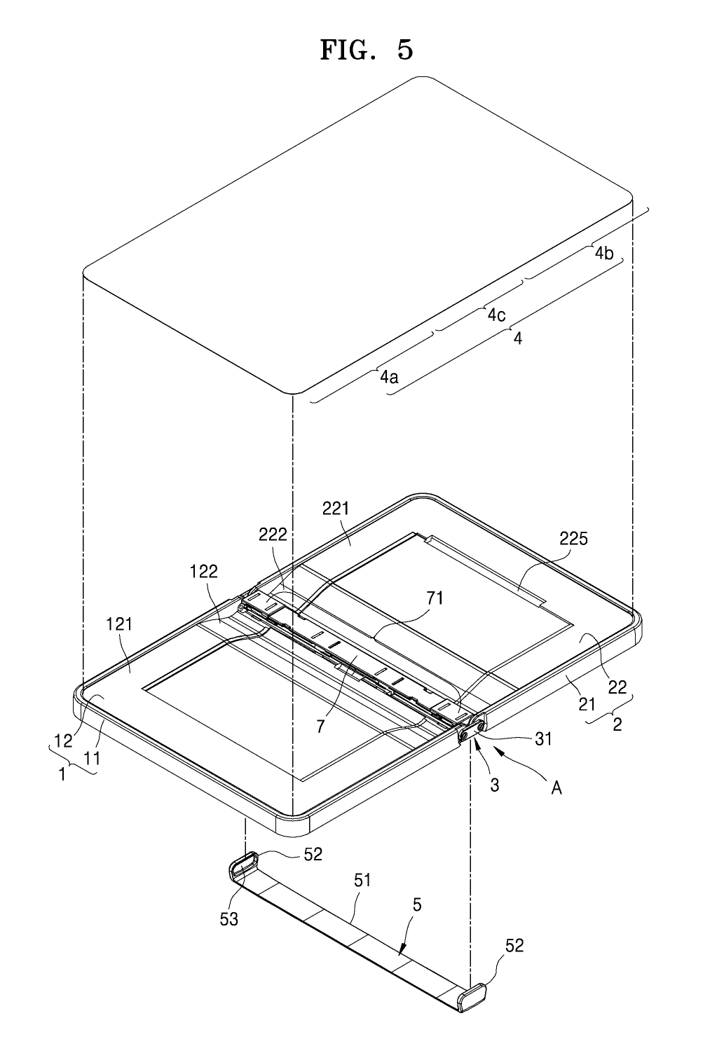

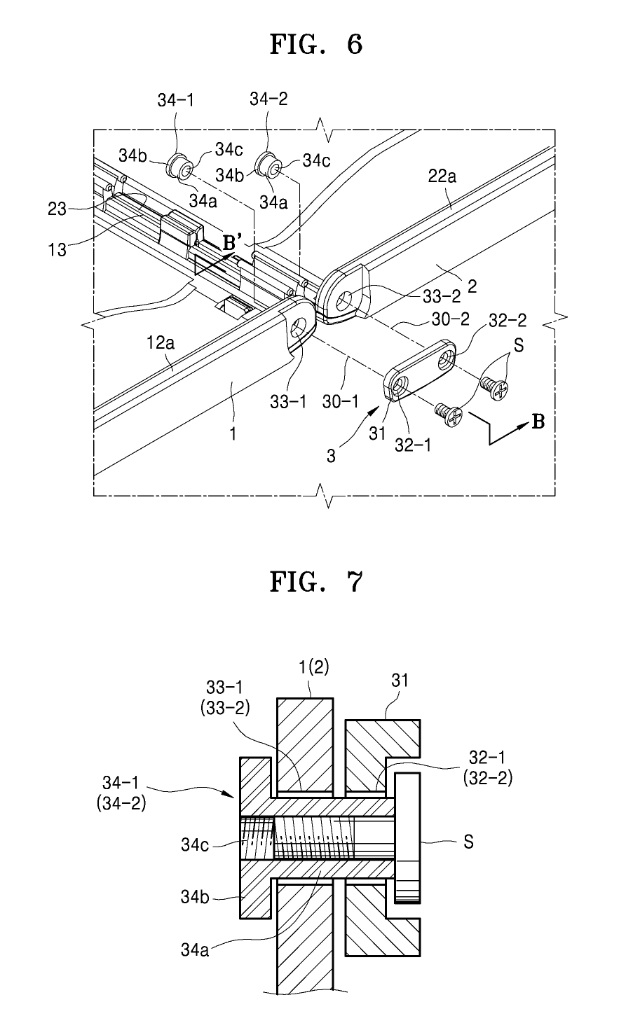

FIG. 5 is an exploded perspective view illustrating the foldable device of FIG. 1, according to an exemplary embodiment. FIG. 6 is an enlarged view illustrating portion “A” of FIG. 5, according to an exemplary embodiment. FIG. 7 is a cross-sectional view taken along line B-B′ of FIG. 6, according to an exemplary embodiment.

Referring to FIG. 5, the first body 1 includes a first base cover 11 and a first frame 12. The first base cover 11 defines an outer appearance of the first body 1. The first frame 12 is received in the first base cover 11. The first frame 12 includes a first support 121 that supports the first part 4a of the flexible display device 4 and a first receiver 122 that is inclined downward from the first support 121. The first receiver 122 corresponds to the third part 4c of the flexible display device 4. The second body 2 includes a second base cover 21 and a second frame 22. The second base cover 21 defines an outer appearance of the second body 2. The second frame 22 is received in the second base cover 21. The second frame 22 includes a second support 221 that supports the second part 4b of the flexible display device 4 and a second receiver 222 that is inclined downward from the second support 221. The second receiver 222 corresponds to the third part 4c of the flexible display device 4.

The first and second receivers 122 and 222 face each other when the first and second bodies 1 and 2 are folded, as shown in FIG. 3, to form a receiving space AS (see FIG. 3) in which the curved portion 4d is received. For example, the first and second receivers 122 and 222 are respectively inclined from the first and second supports 121 and 221 to be far from the third part 4c of the flexible display device 4.

Referring to FIGS. 5 and 6, a connection unit 3 foldably connects the first and second bodies 1 and 2. According to an exemplary embodiment, the first and second bodies 1 and 2 respectively pivot about two central axes 30-1 and 30-2 that are spaced apart from each other. The connection unit 3 may include a connection bracket 31 in which one pair of first connection holes 32-1 and 32-2 are formed, and one pair of hinge members 34-1 and 34-2. Hinge member 34-1 and 34-2 pass through second connection holes 33-1 and 33-2, respectively formed in the first and second bodies 1 and 2, and are inserted into the one pair of first connection holes 32-1 and 32-2. The second connection holes 33-1 and 33-2 may be respectively formed in both side walls 12a and 22a of the first and second frames 12 and 22.

Referring to FIGS. 6 and 7, each of the hinge members 34-1 and 34-2 includes an insertion portion 34a that has a cylindrical shape and is inserted into each of the second connection holes 33-1 and 33-2 and each of the first connection holes 32-1 and 32-2, and a step portion 34b that has a greater outer diameter than that of the insertion portion 34a. The insertion portions 34a provide the central axes 30-1 and 30-2, about which the first and second bodies 1 and 2 pivot. The step portions 34b are supported in the first and second bodies 1 and 2. Screw holes 34c are axially formed in the insertion portions 34a, respectively. In a state where the insertion portions 34a of the hinge members 34-1 and 34-2 pass through the second connection holes 33-1 and 33-2 and are inserted into the first connection holes 32-1 and 32-2, screws S are inserted into the screw holes 34c from the opposite side of the step portion 34b. Accordingly, the first and second bodies 1 and 2 may be coupled to the connection bracket 31 so that the first and second bodies 1 and 2 may pivot about the insertion portions 34a of the hinge members 34-1 and 34-2. With this connection structure, the first and second bodies 1 and 2 may be connected to each other to change between the unfolded position of FIG. 2 and the folded position of FIG. 3.

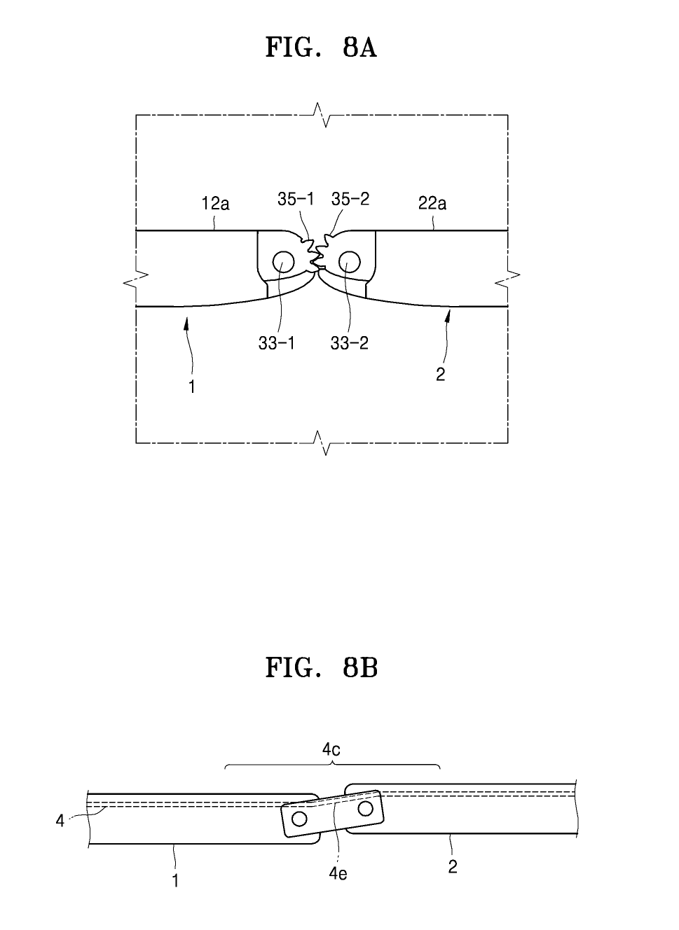

A connection structure for foldably connecting the first and second bodies 1 and 2 is not limited to the connection structure of FIGS. 6 and 7. FIG. 8A is a side view illustrating a modified connection structure for foldably connecting the first and second bodies 1 and 2, according to another exemplary embodiment. The modified connection structure of FIG. 8A may be obtained by adding a gear structure to the connection structure of FIG. 6. Referring to FIG. 8A, first and second gears 35-1 and 35-2 that engage with each other are respectively provided on both side walls 12a and 22a of the first and second bodies 1 and 2. Centers of the first and second gears 35-1 and 35-2 correspond to centers of the first connection holes 33-1 and 33-2, respectively.

Without the first and second gears 35-1 and 35-2, the first and second bodies 1 and 2 do not necessarily simultaneously pivot during a folding/unfolding process, and the first and second bodies 1 and 2 may be misaligned with each other in an unfolded state shown in FIG. 8B. Once the first and second bodies 1 and 2 are misaligned with each other, a level difference 4e may occur in the third part 4c of the flexible display device 4. In the connection structure of FIG. 8A, because the first and second gears 35-1 and 35-2 are engaged with each other, the first and second bodies 1 and 2 simultaneously pivot. Hence, the first and second bodies 1 and 2 are not misaligned during a folding/unfolding process.

Referring back to FIGS. 5 and 6, a cover member 5 surrounds a connecting portion between the first and second bodies 1 and 2 to prevent the inside of the foldable device from being exposed. For example, the cover member 5 may include an extending portion 51 that extends along facing edges 13 and 23 of the first and second bodies 1 and 2 and side walls 52 that are located on both ends of the extending portion 51. Recessed portions 53 that are sunken from inner surfaces of the side walls 52 are formed in the inner surfaces of the side walls 52. The recessed portions 53 are shaped so that the connection bracket 31 may be inserted into the recessed portions 53. The cover member 5 may be coupled to the first and second bodies 1 and 2 by slightly widening the side walls 52, and inserting the connection bracket 31 into the recessed portions 53. When the first and second bodies 1 and 2 are folded, the edges 13 and 23, of the first and second bodies 1 and 2, may be spaced apart from each other, and the inside of the foldable device may be exposed through a space between the edges 13 and 23. The cover member 5 covers the space between the spaced edges 13 and 23 in order to prevent the inside of the foldable device from being exposed. Accordingly, the outer appearance of the foldable device may be improved.

Referring back to FIGS. 2, 3, and 5, the foldable device may further include a movable support member 7. The movable support member 7 includes a movable support 71 that supports the third part 4c of the flexible display device 4. The movable support member 7 is located at a support position to support the third part 4c of the flexible display device 4 when the first and second bodies 1 and 2 are located at the unfolded position. The movable support member 7 supports the third part 4c of the flexible display device 4 between the first and second receivers 122 and 222. When the first and second bodies 1 and 2 change to the folded position, the movable support member 7 is located at a retreat position forming the receiving space AS of the curved portion 4d. That is, the movable support member 7 moves between the retreat position and the support position as the first and second bodies 1 and 2 change between the folded position and the unfolded position. As such, when the first and second bodies 1 and 2 are located at the unfolding position, because the third part 4c of the flexible display device 4 is supported by the movable support member 7, the third part 4c may be spread flat.

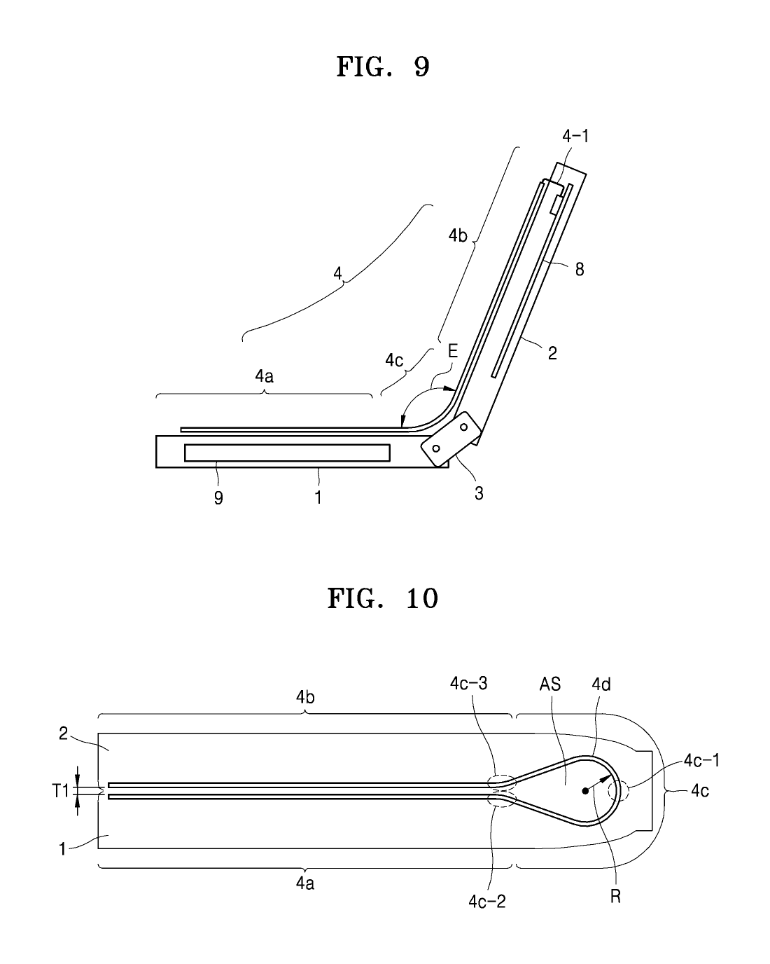

FIG. 9 is a side view illustrating the foldable device according to an exemplary embodiment. Referring to FIG. 9, the first part 4a and the second part 4b of the flexible display device 4 are respectively supported by the first and second bodies 1 and 2. The foldable device includes at least one electrical circuit member for operating the flexible display device 4. The electrical circuit member may include a controller 8 that controls an operation of the foldable device, and a battery 9 that supplies power to the flexible display device 4 and the controller 8. The controller 8 may be, for example, a circuit board including a processing unit that performs a function according to the use of the foldable device. The flexible display device 4 includes a signal line 4-1 that is connected to the controller 8. The signal line 4-1 may be, for example, a flexible printed circuit board (FPCB). The controller 8 may be disposed in the second body 2, and the signal line 4-1 may be provided in the second part 4b of the flexible display device 4. The signal line 4-1 may pass through a slot 225 (see FIG. 5) that is formed in the second frame 22 and may be connected to the controller 8. The battery 9 may be disposed in the first body 1 and may be connected to the controller 8 by using a power supply line. Power may be supplied through the controller 8 and the signal line 4-1 to the flexible display device 4.

The foldable device may be carried and stored in the folded state of FIG. 3, and may be used in the unfolded state of FIG. 2, or in a partially folded state having a predetermined fold angle E, as shown in FIG. 9. Stress may accumulate on the flexible display device 4, particularly, on the third part 4c, due to repeated folding/unfolding processes. The stress may cause deformation of the third part 4c of the flexible display device 4, or delamination at the third part 4c between a plurality of stacked panels of the flexible display devices 4. Accordingly, a method of reducing stress accumulation on the flexible display device 4 is necessary.

Also, because a stiffness of the flexible display device 4 is high at a low temperature, greater stress may be applied to the flexible display device 4 during a folding/unfolding process. Also, because the flexible display device 4 becomes brittle at a low temperature, the flexible display device 4 may be damaged during a folding/unfolding process.

Stress during a folding/unfolding process may be reduced by reducing a stiffness of the flexible display device 4. In general, a stiffness of an elastic material decreases as temperature increases. In this regard, according to an exemplary embodiment, stress may be reduced by temporarily reducing a stiffness of the flexible display device 4 by heating the flexible display device 4 during a folding/unfolding process. Also, at a low temperature, the risk of damage may be reduced by heating the flexible display device 4 and then performing a folding/unfolding process.

FIG. 10 is a side view illustrating a folding state of the foldable device, according to an exemplary embodiment. Referring to FIG. 10, stress generally accumulates on the third part 4c that forms the curved portion 4d. Hence, at least a portion of the third part 4c may be heated in order to reduce stress. For example, a central portion 4c-1 having the lowest radius of curvature of the third part 4c in the folded state, may be heated.

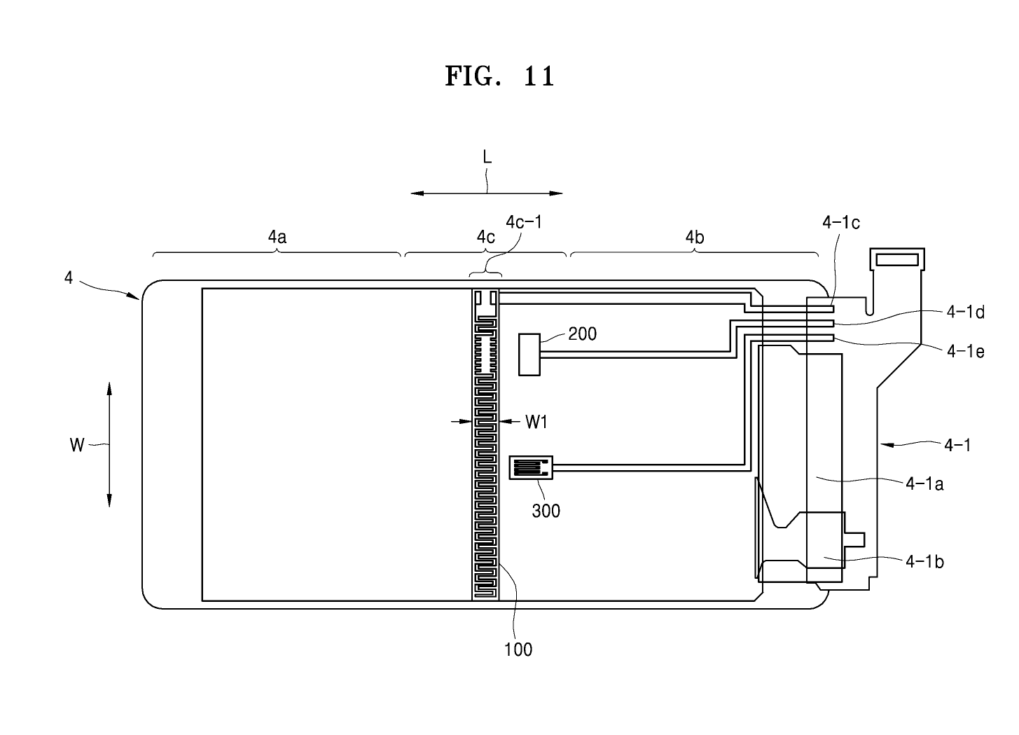

FIG. 11 is a rear view illustrating the flexible display device 4 including a heating member 100, according to an exemplary embodiment. Referring to FIG. 11, the heating member 100 may be disposed on a portion of a rear surface of the flexible display device 4 to correspond to the central portion 4c-1 of the third part 4c. The heating member 100 may be, for example, a flexible resistive substrate including a thin film resistance pattern. The heating member 100 may be located at the central portion 4c-1 of the third part 4c. A heating width W1 of the heating member 100 is not limited and may be appropriately determined to obtain a desired stress reducing effect.

For example, the possible temperature difference that may be obtained by the heating member may be calculated as:
thermal conductivity of the flexible display device 4: about 0.2 W/mK
thermal resistance of the flexible display device 4: 0.001/0.2=0.005 m²K/W
heating member 100: 25 W, 12.7 cm×2.5 cm
heat flow of the heating member 100: 25/(0.127×0.025)=7874 W/m²
temperature difference that may be obtained by the heating member 100: 7874×0.005=39 K

As described above, temperature of 25° C. may be increased to about 64° C., and a temperature of −20° C. may be increased to about 19° C.

The amount of consumption of the battery 9 is calculated as follows:
battery 9: 3.7 V, 200 mmAh, 7.4 Wh
number of folding/unfolding processes a day: 300 times (used 150 times)
heating time at one time: 1 second
total heating time a day: 300 seconds (5 minutes)
amount of consumption of the battery 9: 0.2083 Wh

As described above, when the foldable device is used 150 times a day, power of about 0.21 Wh, about 2.8% of a capacity of the battery 9, is consumed. Accordingly, stress applied to the flexible display device 4 during a folding/unfolding process may be reduced by heating the flexible display device 4 without excess power consumption. Also, because the amount of consumption of the battery 9 is about 0.2083 Wh, the foldable device of the exemplary embodiment may be effectively applied to a rechargeable mobile device. The calculated amount of consumption of the battery 9 is exemplary, and may vary according to factors such as a heating capacity of the heating member 100, a heating time during one folding/unfolding process, a heating temperature, and an environment in which the foldable device is used.

The flexible display device 4 is connected to the controller 8 through the signal line 4-1. For example, the signal line 4-1 includes a first driving signal line 4-1a for driving the display panel 41. When the touch panel 42 is provided, the signal line 4-1 may further include a second driving signal line 4-1b for driving the touch panel 42. The signal line 4-1 may include a third driving signal line 4-1c for driving the heating member 100.

In order to prevent the flexible display device 4 from being overheated, the foldable device may further include a temperature sensor 200 that detects a temperature of the flexible display device 4. The temperature sensor 200 may detect, for example, a temperature of the third part 4c of the flexible display device 4. The temperature sensor 200 may detect a temperature around the heating member 100 of the flexible display device 4. To this end, the temperature sensor 200 may be located adjacent to the heating member 100.

As shown in FIG. 11, the temperature sensor 200 may be disposed on a rear surface of the flexible display device 4 separate from the heating member 100. In this case, the signal line 4-1 may include a fourth driving signal line 4-1d that connects the temperature sensor 200 and the controller 8.

The temperature sensor 200 may be integrally formed with the heating member 100. When the temperature sensor 200 is integrally formed with the heating member 100, the heating member 100 may be a flexible resistive substrate including a thin film resistance pattern and the temperature sensor 200 may be formed on the flexible resistive substrate. In this case, the fourth driving signal line 4-1d may be integrated with the third driving signal line 4-1c.

Referring back to FIG. 10, while the foldable device is folded, a radius of curvature R of the curved portion 4d is greater than an interval T1 between the first and second parts 4a and 4b. Accordingly, boundary portions 4c-2 and 4c-3 of the third part 4c and the first and second parts 4a and 4b are also bent, although less sharply than the central portion 4c-1. Accordingly, in order to reduce stress, the boundary portions 4c-2 and 4c-3 or both the boundary portions 4c-2 and 4c-3 and the central portion 4c-1 may be heated.

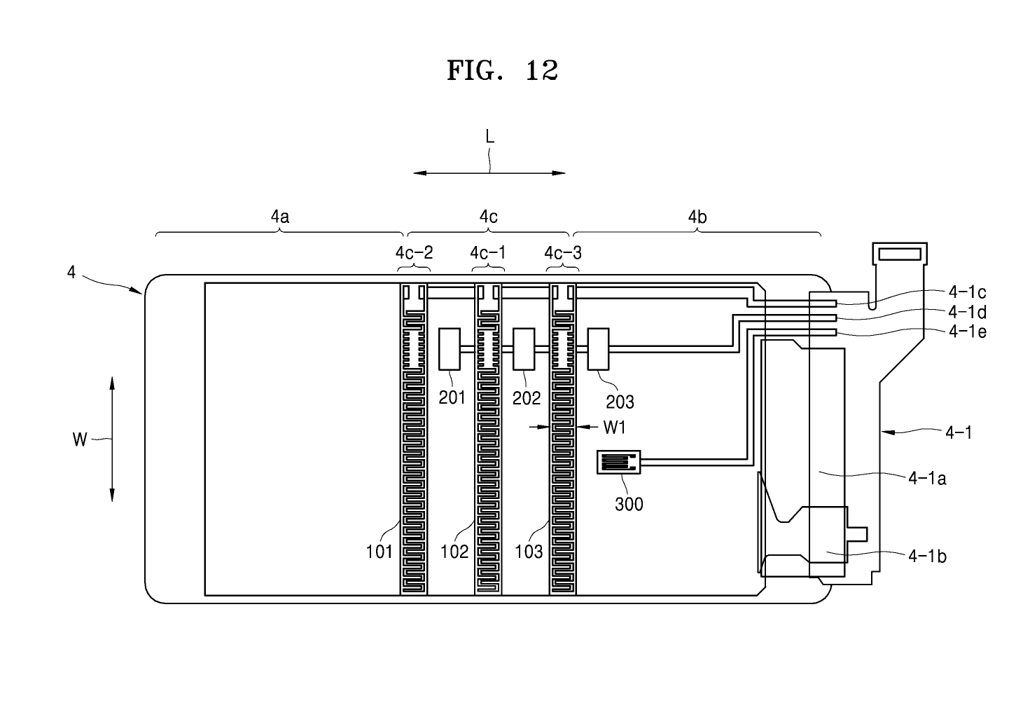

FIG. 12 is a rear view illustrating the flexible display device 4 to which a plurality of heating members 101, 102, and 103 are applied, according to an exemplary embodiment. Referring to FIG. 12, the heating members 101, 102, and 103 are provided on the rear surface of the flexible display device 4. The heating members 101, 102, and 103 are disposed on portions of the rear surface of the flexible display device 4 to respectively correspond to the boundary portion 4c-2, the central portion 4c-1, and the boundary portion 4c-3 of the third part 4c. Each of the heating members 101, 102, and 103 may be, for example, a flexible resistive substrate including a thin film resistance pattern. Also, the heating members 101, 102, and 103 may be formed such that three thin film resistance patterns, respectively corresponding to the heating members 101, 102, and 103, are provided on one flexible resistive substrate. The signal line 4-1 may include the third driving signal line 4-1c for driving the heating members 101, 102, and 103.

A temperature of the flexible display device 4 may be detected at one portion or a plurality of portions. For example, the foldable device may include three temperature sensors 201, 202, and 203 respectively corresponding to the heating members 101, 102, and 103, or one or two selected from the three temperature sensors 201, 202, and 203. The temperature sensors 201, 202, and 203 may be integrally formed with the heating members 101, 102, and 103, respectively. When the temperature sensors 201, 202, and 203 are integrally formed with the heating members 101, 102, and 103, for example, each of the heating members 101, 102, and 103 may be a flexible resistive substrate including a thin film resistance pattern, and the temperature sensors 201, 202, and 203 may be formed on the flexible resistive substrate. Alternatively, the temperature sensors 201, 202, and 203 may be integrally into one flexible resistive substrate on which three thin film resistance patterns, respectively corresponding to the heating members 101, 102, and 103, are formed. In this case, the fourth driving signal line 4-1d for driving the temperature sensors 202, 202, and 203 may be integrated with the third driving signal line 4-1c.

The controller 8 may detect a temperature of the flexible display device 4 from a detection signal of the temperature sensor 200 or the temperature sensors 201, 202, and 203, and may drive the heating member 100 or the heating members 101, 102, and 103 based on the detected temperature. The controller 8 may drive the heating member 100 or the heating members 101, 102, and 103 so the temperature of the flexible display device 4 does not exceed a temperature limit based on the detected temperature. The temperature limit may be, but is not limited to, about 70° C. The temperature limit may be appropriately determined so as to prevent the flexible display device 4 from thermal damage and may be determined in consideration of a material and a stiffness of the flexible display device 4.

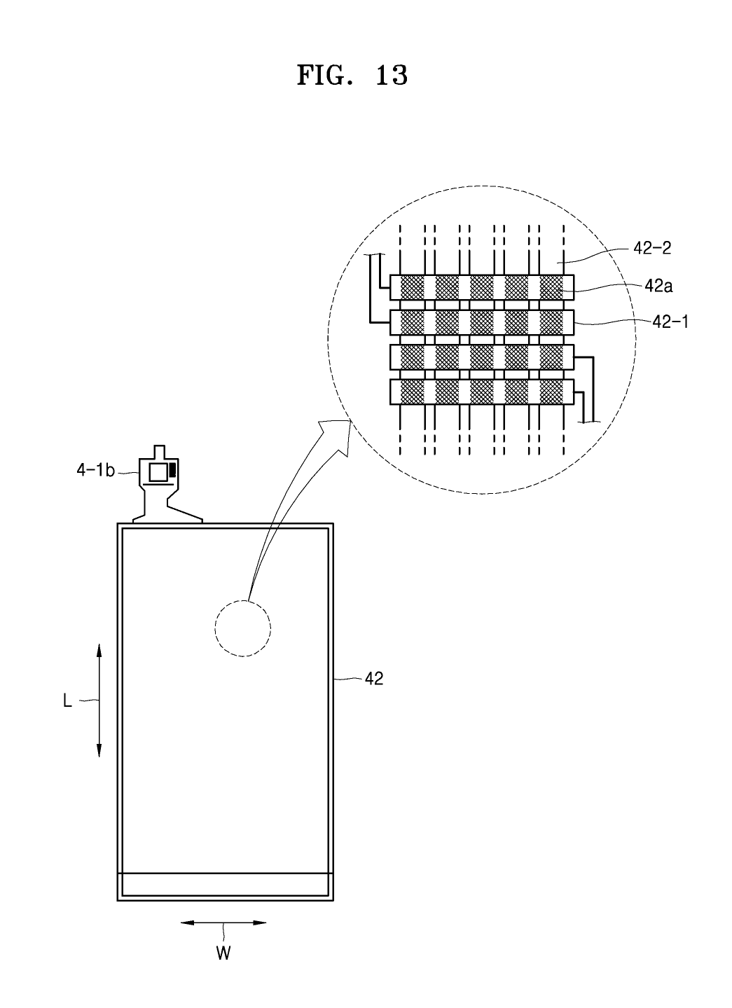

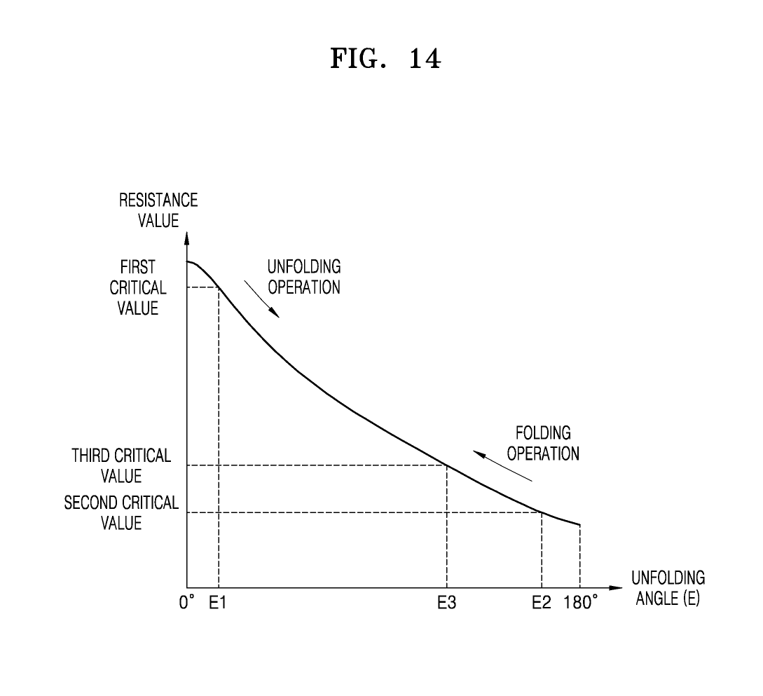

The heating member 100, or the heating members 101, 102, and 103, may be realized by using a transparent electrode of the touch panel 42. FIG. 13 is a plan view illustrating a heating member realized by using a transparent electrode of the touch panel 42, according to an exemplary embodiment.

Referring to FIG. 13, the touch panel 42 includes a plurality of horizontal electrodes 42-1 and vertical electrodes 42-2 for determining whether a plurality of touch cells 42a are touched. The plurality of horizontal electrodes 42-1 extend in a width direction W and are arranged to be spaced apart from one another in a length direction L. The plurality of vertical electrodes 42-2 extend in the length direction L and are arranged to be spaced apart from one another in the width direction W. The horizontal electrodes 42-1 and the vertical electrodes 42-2 are, for example, transparent electrodes formed of indium tin oxide (ITO). The heating member 100 may be realized by supplying current to one or more horizontal electrodes 42-1 corresponding to the central portion 4c-1 of the third part 4c from among the plurality of horizontal electrodes 42-1. Also, the heating members 101, 102, and 103 may be realized by supplying current to one or more horizontal electrodes 42-1 corresponding to the central portion 4c-1 and the boundary portions 4c-2 and 4c-3 of the third part 4c from among the horizontal electrodes 42-1.

The heating member 100, or the heating members 101, 102, and 103, may be driven during a folding/unfolding process in which the foldable device changes between a folding position and an unfolding position. To this end, as shown in FIGS. 11 and 12, the foldable device includes a folding/unfolding operation sensor 300 that detects whether a folding/unfolding operation starts. The signal line 4-1 further includes a fifth driving signal line 4-1e for driving the folding/unfolding operation sensor 300.

When the flexible display device 4 folds/unfolds, tensile stress is applied to a rear surface of the flexible display device 4 and compressive stress is applied to a surface of the flexible display device 4. Due to the tensile stress and the compressive stress, a length of the flexible display device 4 changes slightly. For example, a strain gauge for detecting a slight change in the length of the flexible display device 4 may be used as the folding/unfolding operation sensor 300. The strain gauge may be disposed on or adjacent to the third part 4c of the flexible display device 4 that undergoes a great change in curvature during a folding/unfolding process. However, the exemplary embodiment is not limited thereto, and the strain gauge may be disposed on or adjacent to the first part 4a or the second part 4b of the flexible display device 4.

A resistance value of the strain gauge varies according to a strain that is produced due to stress. For example, the resistance value of the strain gauge increases when the foldable device folds and decreases when the foldable device unfolds. That is, the resistance value of the strain gauge is inversely proportional to the fold angle E of the foldable device.

FIG. 14 is a graph illustrating a relationship between the unfolding angle E of the foldable device and a resistance value of the strain gauge, according to an exemplary embodiment. FIG. 14 illustrates only how the resistance value of the strain gauge changes as the unfolding angle E of the foldable device changes, and the scope of exemplary embodiments is not limited to the graph of FIG. 14. Accordingly, the controller 8 may detect a folding operation and an unfolding operation according to whether the resistance value of the strain gauge increases or decreases.

For example, the controller 8 may determine that the unfolding operation starts when the resistance value decreases to be less than a first critical value, and may determine that the unfolding operation is completed when the resistance value continuously decreases to be less than a second critical value. The controller 8 may determine that the folding operation starts when the resistance value increases to be greater than the second critical value and may determine that the folding operation is completed when the resistance value continuously increases to be greater than the first critical value. For example, an unfolding angle E1 corresponding to the first critical value may be equal to or greater than about 10° and an unfolding angle E2 corresponding to the second critical value may be equal to or greater than 170°, but the scope of exemplary embodiments is not limited thereto. The fold angles E1 and E2 of the foldable device, respectively corresponding to the first and second critical values, may be determined in consideration of a time when a change in curvature of the third part 4c of the flexible display device 4 begins to change, such as when the foldable device unfolds and folds, the current capacity of the battery 9 according to a heating time, etc.

The foldable device may be used in a state having a predetermined fold angle E3 that is between a folded state and an unfolded state. The controller 8 may determine whether the foldable device reaches the use state according to whether, when the foldable device folds and unfolds, the resistance value reaches a third critical value corresponding to the fold angle E3 and then changes, and may stop heating when the foldable device reaches the use state. Although the foldable device may be used in various ways, the fold angle E3 may generally range from about 90° to about 150°. For example, the fold angle E3 may be about 120°.

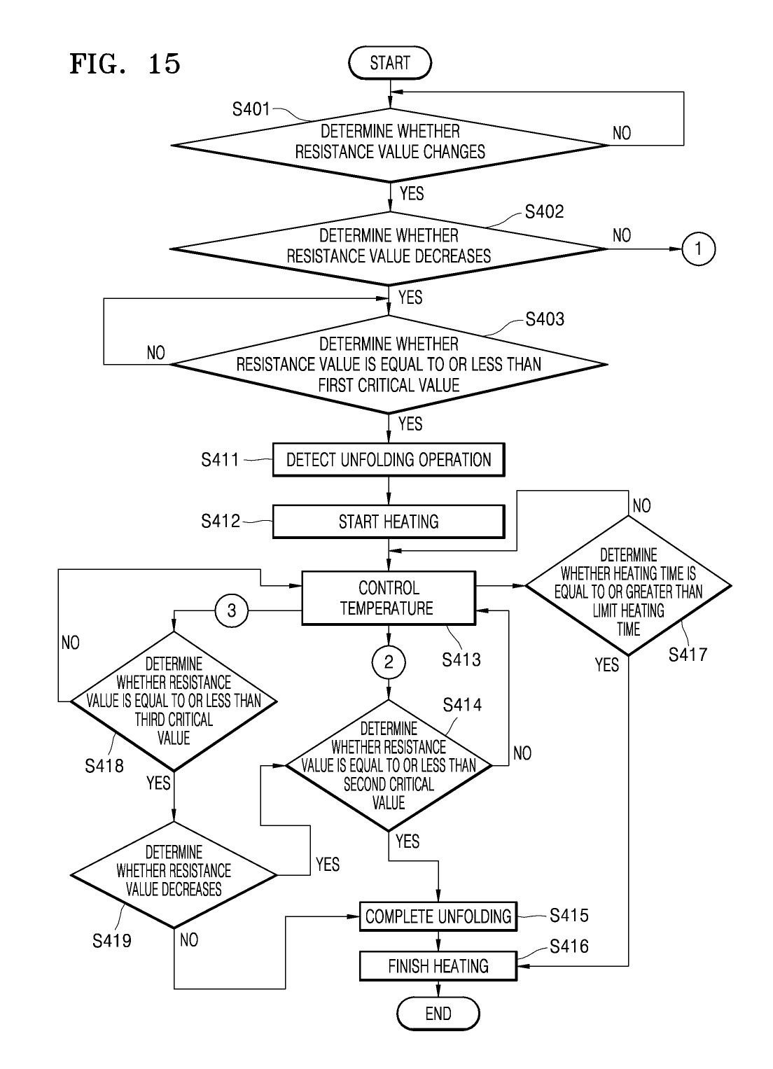

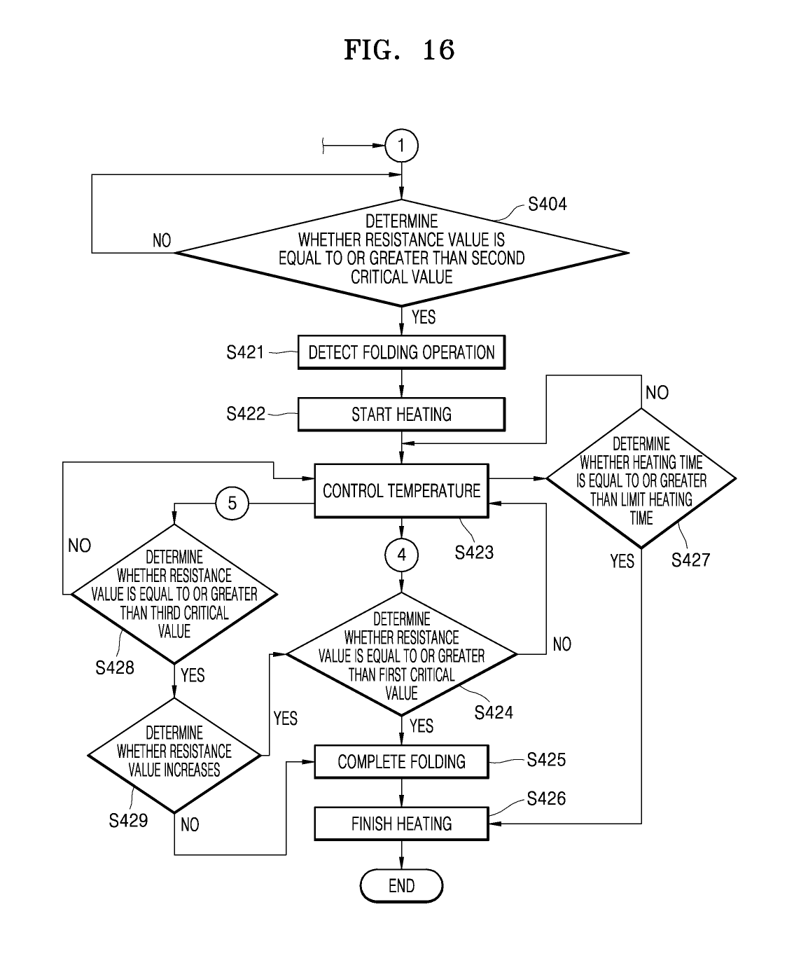

FIGS. 15 and 16 are flowcharts illustrating a folding/unfolding process according to an exemplary embodiment. The folding/unfolding process will be explained with reference to FIGS. 15 and 16.

Referring to FIG. 15, in operation S401, the controller 8 determines whether a resistance value of the folding/unfolding operation sensor 300 changes. If it is determined by the controller 8 in operation S401 that the resistance value changes, the folding/unfolding process proceeds to operation S402. In operation S402, the controller 8 determines whether the resistance value increases or decreases. If it is determined by the controller 8 that the resistance value decreases, the folding/unfolding process proceeds to operation S403. In operation S403, the controller 8 determines whether the resistance value decreases to reach a first critical value. If it is determined by the controller 8 in operation S403 that the resistance value decreases to reach the first critical value, the folding/unfolding process proceeds to operation S411. In operation S411, the controller 8 determines that an unfolding operation starts. In operation S412, the controller 8 starts heating by driving the heating member 100 or the heating members 101, 102, and 103. In operation S413, the controller 8 controls the heating member 100 or the heating members 101, 102, or 103 so a temperature of the flexible display device 4 does not exceed a temperature limit.

A control process is divided into a case where the foldable device is used at the fold angle E3 and a case where the foldable device is not used at the fold angle E3. When the foldable device is not used at the fold angle E3, the control process proceeds to step (2). In operation S414, the controller 8 determines whether the resistance value reaches a second critical value. If it is determined by the controller 8 in operation S414 that the resistance value reaches the second critical value, the folding/unfolding process proceeds to operation S415. In operation S415, the controller 8 determines that the unfolding operation is completed. In operation S416, the controller 8 finishes the heating.

When the unfolding operation starts and then is arbitrarily stopped by a user before the resistance value reaches the second critical value, because the heating is not finished, thermal impact may be applied to the flexible display device 4 and the battery 9 may be continuously consumed. In operation S417, the controller 8 determines whether a heating time after the heating starts exceeds a heating time limit. If it is determined by the controller 8 in operation S417 that the heating time exceeds the heating time limit, the folding/unfolding process proceeds to operation S416. In operation S416, the controller 8 finishes the heating.

When the foldable device is used at the fold angle E3, the control process proceeds to step (3). In operation S418, the controller 8 determines whether the resistance value reaches a third critical value. If it is determined by the controller 8 in operation S418 that the resistance value reaches the third critical value, the folding/unfolding process proceeds to operation S419. In operation S419, the controller 8 determines whether the resistance value continuously decreases. If it is determined by the controller 8 in operation S419 that the resistance value does not decrease after reaching the third critical value, the folding/unfolding process proceeds to operation S415. In operation S415, the controller 8 determines that the foldable device reaches the fold angle E3 and thus the unfolding operation is completed. In operation S416, the controller 8 finishes the heating. Otherwise, if it is determined by the controller 8 in operation S419 that the resistance value continuously decreases after reaching the third critical value and the unfolding operation of the foldable device is continuously performed, the folding/unfolding process proceeds to operation S414. In operation S414, the controller 8 determines whether the resistance value reaches the second critical value. If it is determined by the controller 8 in operation S414 that the resistance value reaches the second critical value, the folding/unfolding process proceeds to operation S415. In operation S415, the controller 8 determines that the unfolding operation is completed. In operation S416, the controller 8 finishes the heating.

Otherwise, if it is determined by the controller 8 in operation S402 that the resistance value increases, the control process proceeds to step (1). Referring to FIG. 16, in operation S404, the controller 8 determines whether the resistance value increases to reach the second critical value. If it is determined by the controller 8 in operation S404 that the resistance value increases to reach the second critical value, the folding/unfolding process proceeds to operation S421. In operation S421, the controller 8 determines that a folding operation starts. In operation S422, the controller 8 starts heating by driving the heating member 100 or the heating members 101, 102, and 103. In operation S423, the controller 8 controls the heating member 100 or the heating members 101, 102, and 103 so a temperature of the flexible display device 4 does not exceed a temperature limit.

The control process is divided into a case where the foldable device is used at the fold angle E3 and a case where the foldable device is not used at the fold angle E3. When the foldable device is not used at the fold angle E3, the control process proceeds to step (4). In operation S424, the controller 8 determines whether the resistance value reaches the first critical value. If it is determined by the controller 8, in operation S424, that the resistance value reaches the first critical value, the folding/unfolding process proceeds to operation S425. In operation S425, the controller 8 determines that the folding operation is completed. In operation S426, the controller 8 finishes the heating.

When the folding operation starts and then is arbitrarily stopped by the user before the resistance value reaches the first critical value, because the heating is not finished, thermal impact may be applied to the flexible display device 4 and the battery 9 may be continuously consumed. In operation S427, the controller 8 determines whether a heating time after the heating starts exceeds a heating time limit. If it is determined by the controller 8 in operation S427 that the heating time exceeds the heating time limit, the folding/unfolding process proceeds to operation S426. In operation S426, the controller 8 finishes the heating.

When the foldable device is used at the fold angle E3, the control process proceeds to step (5). In operation S428, the controller 8 determines whether the resistance value reaches the third critical value. If it is determined by the controller 8 in operation S428 that the resistance value reaches the third critical value, the folding/unfolding process proceeds to operation S429. In operation S429, the controller 8 determines whether the resistance value continuously increases. Otherwise, if it is determined by the controller 8 in operation S429 that the resistance value does not increase after reaching the third critical value, the folding/unfolding process proceeds to operation S425. In operation S425, the controller 8 determines that the foldable device reaches the fold angle E3 and the folding operation is completed. In operation S426, the controller 8 finishes the heating. If it is determined by the controller 8, in operation S429, that the resistance value continuously increases after reaching the third critical value and the folding operation of the foldable device is continuously performed, the folding/unfolding process proceeds to operation S424. In operation S424, the controller 8 determines whether the resistance value reaches the first critical value. If it is determined by the controller 8 in operation S424 that the resistance value reaches the first critical value, the folding/unfolding process proceeds to operation S425. In operation S425, the controller 8 determines that the folding operation is completed. In operation S426, the controller 8 finishes the heating.

Irrespective of whether the foldable device unfolds or folds at the fold angle E3, the flexible display device 4 may be heated as described with reference to the flowcharts of FIGS. 15 and 16.

In this structure, stress applied to the flexible display device 4 during a folding/unfolding process may be reduced by heating the flexible display device 4 when the foldable device changes among a folded state, an unfolded state, and a state having the fold angle E3.

While one or more exemplary embodiments have been described with reference to the figures, it will be understood by those of ordinary skill in the art that various changes in form and details may be made without departing from the spirit and scope as defined by the following claims and their equivalents. Accordingly, the true technical scope of the inventive concept is defined by the appended claims.

What is claimed is:

1. A foldable device comprising:
a flexible display;
a first body and a second body that support the flexible display, the first body and the second body foldably connected to each other and configured to deform between a folded position and an unfolded position;
a heating member configured to heat a portion of the flexible display disposed at a location between which the first body and the second body are connected; and
a controller configured to drive the heating member to heat the portion in response to the deformation.

2. The foldable device of claim 1, wherein the heating member is disposed at the location between which the first body and the second body are connected.

3. The foldable device of claim 1, wherein the heating member comprises a plurality of the heating members that are respectively disposed on a central portion of the flexible display, a portion of the flexible display at an edge of the first body and a portion of the flexible display at an edge of the second body.

4. The foldable device of claim 1, further comprising a temperature sensor configured to detect a temperature of the portion,
wherein the controller drives the heating member based on the temperature of the portion.

5. The foldable device of claim 1, further comprising a fold operation sensor configured to determine movement of the first and second bodies between the folded position and the unfolded position,
wherein the controller is further configured to detect deformation based on a detection signal of the fold operation sensor and drive the heating member based on the detection signal.

6. The foldable device of claim 5, wherein the fold operation sensor comprises a strain gauge having a resistance value that varies according to the deformation,
wherein the controller is further configured to determine at least one of a folding operation and an unfolding operation based on a change in the resistance value.

7. The foldable device of claim 6, wherein in response to the resistance value decreasing to reach a first critical value, the controller is configured to determine a start of the unfolding operation and drive the heating member to start heating the portion.

8. The foldable device of claim 7, wherein in response to the resistance value maintaining a value, the controller is configured to disable the heating member.

9. The foldable device of claim 6, wherein in response to the resistance value increasing to reach a second critical value, the controller is further configured to determine a start of the folding operation and drive the heating member to start heating the third part.

10. The foldable device of claim 9, wherein in response to the resistance value maintaining a value, the controller is configured to disable the heating member.

11. A portable device comprising:
a flexible display;
a sensor configured to detect active deformation of the flexible display and output a fold status signal indicating the active deformation;
a heater configured to heat a portion of the flexible display; and
a controller configured to control the heater to heat the portion in accordance with the fold status signal.

12. The portable device of claim 11, further comprising:
a first body foldably connected to a second body via a hinge member,
wherein the flexible display is supported by the first body and the second body and the heater is disposed adjacent to a portion of the flexible display that corresponds to a position of the hinge member.

13. The portable device of claim 11, wherein the controller is further configured to heat the portion in response to the sensor outputting the fold status signal.

14. The portable device of claim 13, wherein the controller is further configured to disable heating the portion in response to the sensor detecting absence of active deformation.

15. The portable device of claim 14, wherein the controller is further configured to disable heating the portion in response to expiration of a maximum heating time.

16. A method of protecting a flexible display, the method comprising:
detecting active deformation of a flexible display panel and outputting a fold status signal indicating the detected active deformation; and
based on the detecting, heating a portion of the flexible display panel by using a heater.

17. The method of claim 16, wherein the flexible display is formed within a first body and a second body that are connected via a hinge member, and the portion of the flexible display panel corresponds to a position of the hinge member.

18. The method of claim 15, wherein the portion is heated in response to determining a deformation of the flexible display panel.

19. The method of claim 18, wherein the heating of the portion is disabled in response to detecting absence of active deformation.

20. The method of claim 19, wherein the heating of the portion is disabled in response to expiration of a maximum heating time.
